(19) United States
(12) Patent Application Publication
(10) Pub. No.: US 2010/0123741 A1
(43) Pub. Date: May 20, 2010

(54) METHOD OF DRIVING A LIGHT SOURCE, LIGHT SOURCE APPARATUS FOR PERFORMING THE METHOD AND DISPLAY APPARATUS HAVING THE LIGHT SOURCE APPARATUS

(75) Inventors: Ho-Sik SHIN, Anyang-si (KR); Ju-Young YOON, Seoul (KR); Si-Joon SONG, Suwon-si (KR); Yong-Hoon KWON, Asan-si (KR); Sang-Chul BYUN, Anyang-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/612,962

(22) Filed: Nov. 5, 2009

(30) Foreign Application Priority Data
Nov. 18, 2008 (KR) 2008-0114547

(51) Int. Cl. G09G 5/10

(52) U.S. Cl. 345/690; 345/211

(57) ABSTRACT

A method of driving a light source in a normal mode and an increased luminance mode, based on a gradation data of an image signal, by using driving blocks each having a plurality of light-emitting blocks, includes applying, during the increased luminance mode, both a first driving voltage which drives a first driving block of the driving blocks during the normal mode, and a second driving voltage which drives a second driving block of the driving blocks during the normal mode, to the first driving block to increase a luminance of the first driving block when the first driving block is driven by a luminance greater than a luminance corresponding to the gradation data of the image signal.

This application claims priority to Korean Patent Application No. 2008-114547, filed on Nov. 18, 2008, and all the benefits accruing therefrom under 35 U.S.C. §119, the contents of which in its entirety are herein incorporated by reference.

### BACKGROUND OF THE INVENTION

1. Field of the Invention

Exemplary embodiments of the present invention provide a method of driving a light source, a light source apparatus for performing the method and a display apparatus having the light source apparatus. More particularly, exemplary embodiments of the present invention provide a method of driving a light source in which light-emitting blocks are individually driven, a light source apparatus for performing the method and a display apparatus having the light source apparatus.

2. Description of the Related Art

Generally, a liquid crystal display (“LCD”) device includes an LCD panel which displays an image thereon by controlling a light transmittance of liquid crystal provided with light from a backlight assembly disposed below the LCD panel.

The backlight assembly typically includes a light source which generates the light required to display an image on the LCD panel. The light source may include a cold cathode fluorescent lamp (“CCFL”), a flat fluorescent lamp (“FFL”) or a light-emitting diode (“LED”), for example, to generate the light.

When the CCFL or the FFL is employed as a light source, however, a power consumption of the LCD device is substantially increased as compared to when the LED is used. Moreover, characteristics of the LCD device deteriorate due to heat generation when the CCFL or the FFL is used. In addition, lamps used with the CCFL or the FFL are easily broken and/or damaged by impact and/or vibration, for example. Moreover, a temperature of the lamps associated with the CCFL or the FFL is not uniform, and luminances of the lamps therefore vary, and a display quality of the LCD device is thereby substantially reduced when using the CCFL or the FFL as the light source.

On the other hand, the LED is easily manufactured into a chip shape, and the LED has a substantially higher luminance and substantially lower power consumption than other light sources such as the CCFL and the FFL. As a result, the LED is typically used as the backlight assembly in the LCD device.

The backlight assembly, having the LED as a light source, typically includes a light source module and a plurality of direct current-to-direct current (“DC-DC”) converting parts. The light source module is divided into driving blocks. The DC-DC converting parts are electrically connected to each of the driving blocks to provide a driving voltage to light-emitting blocks included in each of the driving blocks. A number of required DC-DC converting parts corresponds to a number of the driving blocks. A maximum output power of the DC-DC converting part is adjusted such that a plurality of the LEDs included in the light-emitting blocks is driven in a full white mode when required.

However, since the required number of the DC-DC converting parts corresponds to the number of the driving blocks, the required number of the DC-DC converting parts is increased as a size of the LCD device increases. Thus, a manufacturing cost of the LCD device is substantially increased. Moreover, during operation, a predetermined light-emitting block is sometimes driven at a higher luminance level than a luminance level of a white driving luminance. This must be considered in designing the DC-DC converting part to harmonize a driving condition of the LCD device, and a manufacturing cost thereof is therefore substantially increased.

### BRIEF SUMMARY OF THE INVENTION

Exemplary embodiments of the present invention provide a method of driving a light source in which an effectiveness of driving a plurality of light-emitting blocks is substantially improved.

Exemplary embodiments of the present invention also provide a light source apparatus for performing the method.

Exemplary embodiments of the present invention also provide a liquid crystal display (“LCD”) apparatus having the light source apparatus.

According to an exemplary embodiment of the present invention, a method of driving a light source in a normal mode and an increased luminance mode, based on a gradation data of an image signal, by using driving blocks each having a plurality of light-emitting blocks is provided. In the method, both a first driving voltage, which drives a first driving block of the driving blocks during the normal mode, and a second driving voltage, which drives a second driving block of the driving blocks during the normal mode, are applied to the first driving block during the increased luminance mode to increase a luminance of the first driving block when the first driving block is driven by a luminance greater than a predetermined luminance value corresponding to the gradation data of the image signal. The increased luminance mode includes a boosting mode and a scanning mode.

In an exemplary embodiment of the present invention, the second driving block is adjacent to the first driving block.

In an exemplary embodiment of the present invention, the luminance of the first driving block is substantially greater than a luminance of the second driving block.

According to an alternative exemplary embodiment of the present invention, a light source apparatus includes a first driving block and a second driving block each comprising a plurality of light-emitting blocks, a first drive chip and a second drive chip comprising a first output terminal and a second output terminal, respectively, a switching part and a switching control part. The switching part includes a plurality of switching elements connected to the first output terminal and the second output terminal, and switching elements of the plurality of switching elements are connected in electrical parallel with each other. The switching part is configured to selectively output at least one of a first driving voltage from the first drive chip and a second driving voltage from a second drive chip to at least one of the first driving block and the second driving block. The switching control part turns on first switching elements of the plurality of switching elements connected to the first driving block and turns off second switching elements of the plurality of switching elements connected to the second driving block to increase a luminance of the first driving block when the first driving block is driven by a luminance value greater than a luminance corresponding to a gradation data of an image signal.

In an exemplary embodiment of the present invention, the luminance of the first driving block is substantially greater than a luminance of the second driving block.

In an exemplary embodiment of the present invention, the first drive chip and the second drive chip may include a multi-channel current control part and a DC-DC converting part. The multi-channel current control part may include input terminals connected to output terminals of each light-emitting block of the plurality of light-emitting blocks included in the first driving block and the second driving block. The multi-channel current control part may be configured to control an amplitude of a driving current applied to each of the light-emitting blocks based on a plurality of feedback signals that are applied to the input terminals from each of the light-emitting blocks. The DC-DC converting part may convert an amplitude of one of the first driving voltage and the second driving voltage applied to one of the first driving block and the second driving block based on a control signal from the multi-channel current control part.

In an exemplary embodiment of the present invention, the DC-DC converting part may include an inductor, a switching element, a diode and a capacitor. The inductor may include a first terminal electrically connected to a voltage source. The switching element may include an output terminal electrically connected to a second terminal of the inductor and an input terminal electrically connected to a ground terminal. The diode may include an anode electrically connected to the second terminal of the inductor and the output terminal of the switching element, and the capacitor may be electrically connected between a cathode of the diode and the ground terminal

In an exemplary embodiment of the present invention, the light source apparatus may further include output control switching elements connected to output terminals of each light-emitting block of the plurality of light-emitting blocks included in the first driving block and the second driving block. The switching control part either turns on the output control switching elements or turns off the output control switching elements, based on a driving mode of each of the light-emitting blocks.

In an exemplary embodiment of the present invention, the switching control part may control the first switching elements and the second switching elements such that at least one of the first driving voltage and the second driving voltage is varied when the output control switching elements are turned off.

In an exemplary embodiment of the present invention, each light-emitting block of the plurality of light-emitting blocks may include white light-emitting diodes (“LEDs”) connected in electrical series with each other.

In an exemplary embodiment of the present invention, each light-emitting block of the plurality of light-emitting blocks may include a red LEDs connected in electrical series with other, green LEDs connected in electrical series with each other, and blue LEDs connected in electrical series with each other.

According to still another alternative exemplary embodiment of the present invention, a display apparatus includes a display panel, a light source module, a first drive chip and a second drive chip, a switching part and a switching control part. The display panel displays an image. The light source module provides the display panel with light, and the light source module includes a first driving block and a second driving block each having a plurality of light-emitting blocks. The first drive chip and the second drive chip include a first output terminal and a second output terminal, respectively. The first drive chip configured to output a first driving voltage to the first output terminal, while the second drive chip configured to output a second driving voltage to the second output terminal. The switching part includes a plurality of switching elements connected to the first output terminal and the second output terminal. Switching elements of the plurality of switching elements are connected in electrical parallel with each other, and the switching part is configured to selectively output at least one of the first driving voltage and the second driving voltage to at least one of the first driving block and the second driving block. The switching control part turns on first switching elements of the plurality of switching elements connected to the first driving block, and turns off second switching elements of the plurality of switching elements connected to the second driving block to increase a luminance of the first driving block when the first block is driven by a luminance value greater than a luminance corresponding to a gradation data of an image signal.

Thus, according to a method of driving a light source, a light source apparatus for performing the method and a display apparatus having the light source apparatus, when a first driving block is to be driven at a higher luminance level than a luminance corresponding to a gradation data of an image signal, a driving voltage normally provided only to a second driving block is provided to the first driving block, e.g., driving voltages are condensed. Therefore, it is not required to design an additional DC-DC converting part to obtain an increased luminance output of the first driving block, thereby substantially reducing manufacturing costs thereof

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is a block diagram of an exemplary embodiment of a display apparatus according to the present invention;

FIG. 2 is a schematic circuit diagram of an exemplary embodiment of a light source driving part of the display apparatus shown in FIG. 1;

FIG. 3 is a schematic circuit diagram of an exemplary embodiment of a DC-DC converting part of the light source driving part shown in FIG. 2;

FIG. 4 is a plan view of an exemplary embodiment of a light source module for explaining an exemplary embodiment of a method of driving a light source in a boosting mode according to the present invention;

FIG. 5 is a plan view of an exemplary embodiment of a light source module for explaining an exemplary embodiment of a method of driving a light source in a scanning mode according to the present invention; and

FIG. 6 is a schematic circuit diagram of an alternative exemplary embodiment of a light source driving part of the display apparatus shown in FIG. 1.

### DETAILED DESCRIPTION OF THE INVENTION

The invention will now be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, exemplary embodiments of the present invention will be described in further detail with reference to the accompanying drawings.

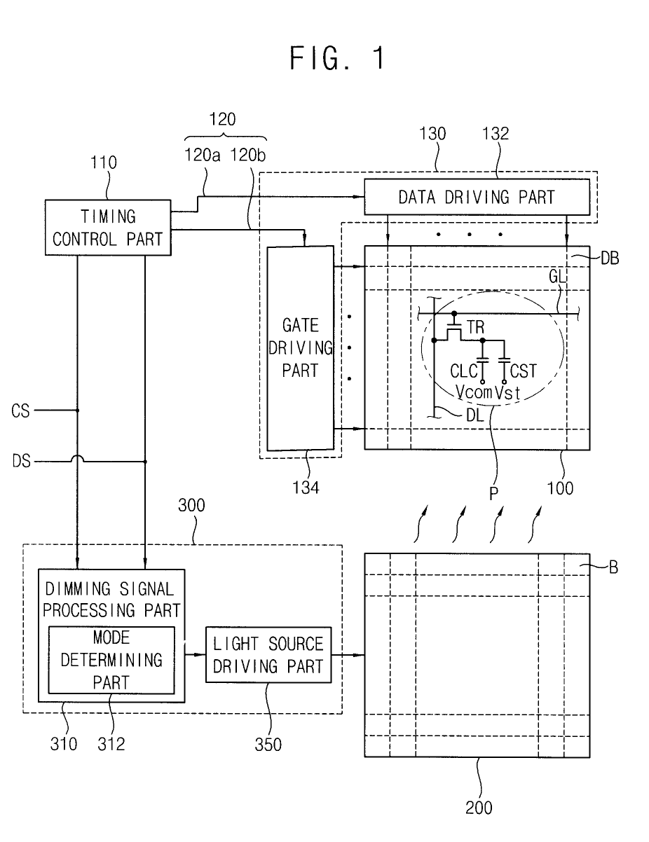

FIG. 1 is a block diagram of an exemplary embodiment of a display apparatus according to the present invention.

Referring to FIG. 1, a display apparatus according to an exemplary embodiment includes a display panel 100, a timing control part 110, a panel driving part 130, a light source module 200 and a local dimming driving part 300.

The display panel 100 includes a plurality of pixels P which display an image. Each pixel P of the plurality of pixels P includes a switching element TR connected to a gate line GL and a data line DL, a liquid crystal capacitor CLC and a storage capacitor CST connected to the switching element TR. The display panel 100 may further include a plurality of display blocks DB. In an exemplary embodiment, a number of the display blocks DB is m×n (where “m” and “n” are natural numbers).

The timing control part 110 receives a control signal CS and an image signal DS from an external device (not shown). The control signal CS may include a vertical synchronizing signal, a horizontal synchronizing signal, a main clock signal, a data enable signal, etc. The vertical synchronizing signal represents a time required for displaying one frame. The horizontal synchronizing signal represents a time required for displaying one line of the one frame. Thus, the horizontal synchronizing signal includes pulses corresponding to a number of the pixels P included in the one line. The data enable signal represents a time required for supplying the pixel P with data. The timing control part 110 generates a timing control signal 120 which controls a driving timing of the panel driving part 130 based on the control signal CS.

The panel driving part 130 drives the display panel 100 using the timing control signal 120 received from the timing control part 110.

The panel driving part 130 according to an exemplary embodiment may include a data driving part 132 and a gate driving part 134. The timing control signal 120 may include a first control signal 120a for controlling a driving timing of the data driving part 132 and a second control signal 120b for controlling a driving timing of the gate driving part 134. In an exemplary embodiment, the first control signal 120a may include a clock signal and a horizontal synchronization signal, and the second control signal 120b may include a vertical synchronization signal.

The data driving part 132 generates a plurality of data signals using the first control signal 120a and the image signal DS, and provides the data line DL with the generated data signals.

The gate driving part 134 generates a gate signal, which activates the gate line GL, using the second control signal 120b, and provides the gate line GL with the generated gate signal.

The light source module 200 according to an exemplary embodiment includes a printed circuit board (“PCB”) having a plurality of light sources mounted thereon. The light source module 200 may include, for example, white light-emitting diodes (“LEDs”) as light sources of the plurality of light sources. In an alternative exemplary embodiment, however, the light source module 200 may include red LEDs, green LEDs and blue LEDs, for example, but alternative exemplary embodiments are not limited thereto. The light source module 200 may be divided into m×n light-emitting blocks B corresponding to the m×n display blocks DB. The light-emitting blocks B are disposed at positions corresponding to the display blocks DB. Each of the light-emitting blocks B may include a plurality of LEDs.

The local dimming driving part 300 includes a dimming signal processing part 310 and a light source driving part 350.

The dimming signal processing part 310 generates a local dimming signal for individually driving the light-emitting blocks using the control signal CS and the image signal DS which are inputted from the external device (not shown).

The dimming signal processing part 310 analyzes a gradation data of the image signal DS to obtain a representative luminance value corresponding to the display blocks B, and determines a dimming level which controls an amount of light emitted from the light-emitting blocks B using the representative luminance value. For example, in an exemplary embodiment, the dimming signal processing part 310 increases a dimming level when the representative luminance value is relatively large, whereas the dimming signal processing part 310 decreases the dimming level when the representative luminance value is relatively small.

The dimming signal processing part 310 according to an exemplary embodiment may further include a mode determining part 312. The mode determining part 312 determines a driving mode of the light source module 200, e.g., a normal mode and an increased luminance mode, and controls the light source driving part 350 in accordance with the determined driving mode.

The light source driving part 350 drives the light source module 200 based on a dimming level by the light-emitting blocks B, which is applied from the dimming signal processing part 310.

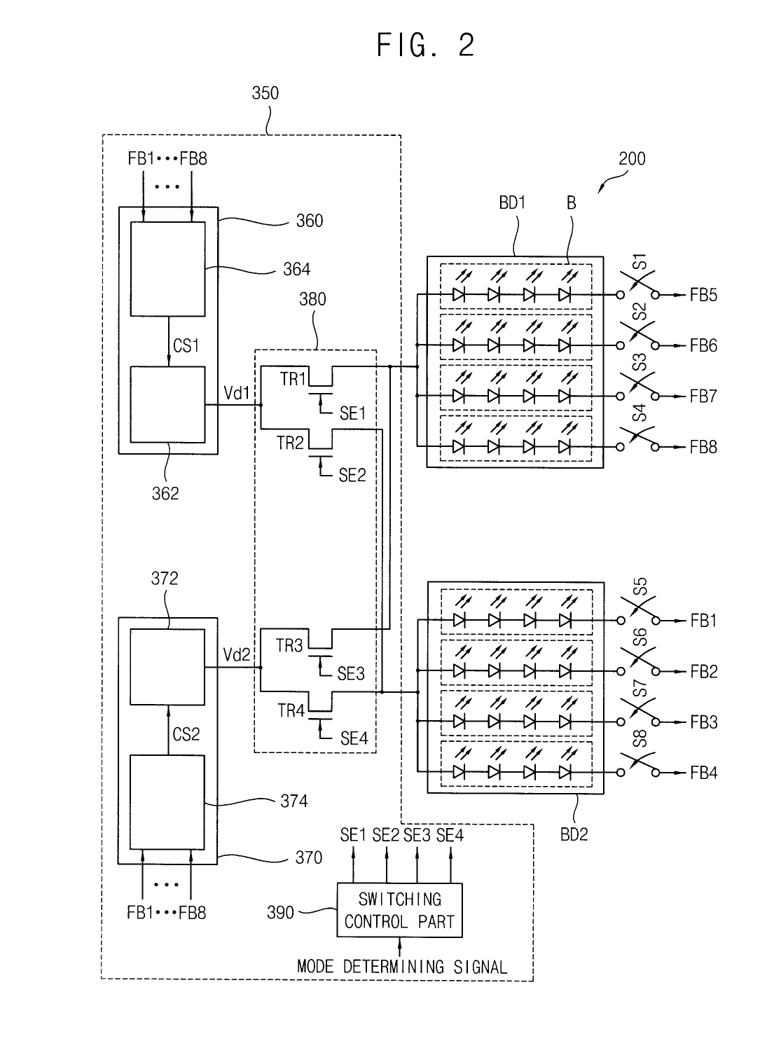

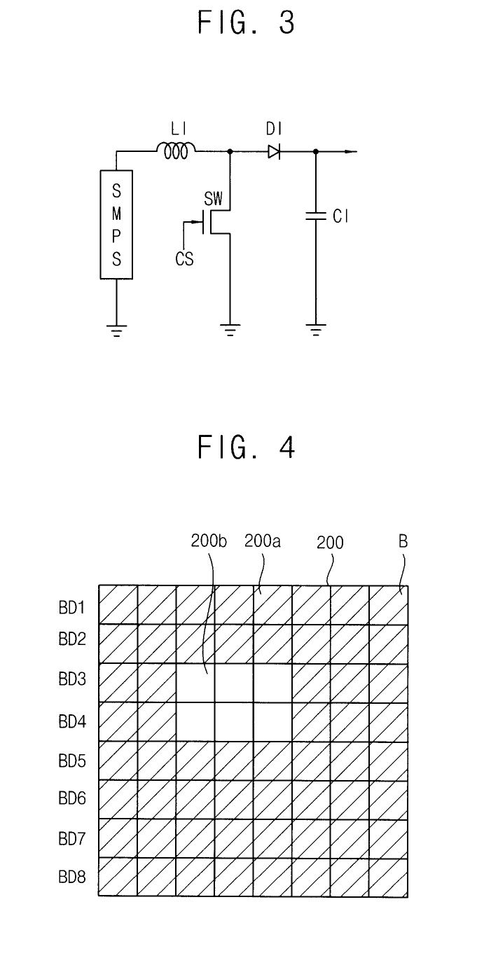

In an exemplary embodiment, the light source driving part 350 includes a plurality of drive chips, a switching part and a switching control part. As will be described in further detail below with reference to FIGS. 2 and 3, the drive chips include a plurality of output channels, e.g., output terminals, and output a driving voltage to driving blocks connected to the output terminals. The switching part includes a plurality of switching elements connected in electrical parallel with each other and to the output terminals, and selectively transmits a driving voltage applied to the output terminal to the driving blocks through the switching element. When a predetermined light-emitting block, e.g., a first light-emitting block is identified to be driven at a higher luminance than a luminance corresponding to a gradation data of the image data DS of the light-emitting blocks, the switching control part turns on switching elements connected to the first driving block and turns off switching elements connected to a second driving block or, alternative to a plurality of second blocks, to increase a luminance of the first driving block. For example, when the light source module 200 includes 8×8 light-emitting blocks B, the light-emitting blocks B are divided into sixteen driving blocks, and two driving blocks are connected to one drive chip. Thus, only eight drive chips are required to simultaneously drive the light source module 200. Two light-emitting blocks B may be connected to one drive chip, and thus a number of the drive chips is substantially decreased.

FIG. 2 is a schematic circuit diagram of an exemplary embodiment of a light source driving part of the display apparatus shown in FIG. 1.

Referring to FIGS. 1 and 2, the light source driving part 350 includes a first drive chip 360, a second drive chip 370, a switching part 380 and a switching control part 390.

The light source module 200 includes a first driving block BD1 and a second driving block BD2. Each of the first driving block BD1 and the second driving block BD2 includes a plurality of the light-emitting blocks B, as shown in FIG. 2. For example, in an exemplary embodiment, both the first driving block BD1 and the second driving block BD2 include four light-emitting blocks B. In addition, each of the light-emitting blocks B may include a diode string of serially connected light-emitting diodes (“LEDs”), for example. More particularly, the light-emitting blocks B may include a white diode string in which white LEDs are connected in electrical series with each other. In an alternative exemplary embodiment, however, the light-emitting blocks B may include a red color diode string in which red LEDs are serially connected in electrical series with each other, a green color diode string in which green LEDs are connected in electrical series with each other and a blue color diode string in which blue LEDs are connected in electrical series with each other. It will be noted that alternative exemplary embodiments are not limited to the foregoing configurations for the light-emitting blocks B.

Still referring to FIG. 2, the first drive chip 360 includes a first direct current-to-direct current (“DC-DC”) converting part 362 and a first multi-channel current control part 364.

The first DC-DC converting part 362 is electrically connected to the first driving block BD1 and the second driving block BD2 through the switching part 380. The first DC-DC converting part 362 converts a first direct current (“DC”) into a second direct current having a voltage level different than the first direct current. In an exemplary embodiment, the first DC-DC converting part 362 converts a voltage applied from a power source part (not shown) into a first driving voltage Vd1 for driving the first driving block BD1. In an exemplary embodiment, the first driving block BD1 and the second driving block BD2 are adjacent to each other, as shown in FIG. 2.

The first multi-channel current control part 364 includes a plurality of input channels, e.g., input terminals, electrically connected to output terminals of the light-emitting blocks B included in the first driving block BD1 and the second driving block BD2. The first multi-channel current control part 364 receives feedback signals FB1 to FB8 from the first driving block BD1 and/or the second driving block BD2. The first multi-channel current control part 364 removes a current deviation between currents of each of the light-emitting blocks B based on the feedback signals FB1 to FB8 to control driving currents flowing through each of the light-emitting blocks B such that the driving currents have uniform values. The first multi-channel current control part 364 outputs a first control signal CS1 for controlling an amplitude of the first driving voltage Vd1 outputted from the first DC-DC converting part 362.

Still referring to FIG. 2, the second drive chip 370 includes a second DC-DC converting part 372 and a second multi-channel current control part 374.

The second DC-DC converting part 372 is electrically connected to the first driving block BD1 and the second driving block BD2 via the switching part 380. The second DC-DC converting part 372 converts a voltage applied from the power source part (not shown) into a second driving voltage Vd2 for driving the second driving block BD2.

The second multi-channel current control part 374 includes a plurality of input channels, e.g., input terminals, electrically connected to the output terminals of the light-emitting blocks B included in the first driving block BD1 and the second driving block BD2. The second multi-channel current control part 374 removes a current deviation between currents of each of the light-emitting blocks B based on the feedback signals FB1 to FB8 to control driving currents flowing through each of the light-emitting blocks B such that the driving currents have a uniform value. The second multi-channel current control part 374 outputs a second control signal CS2 for controlling an amplitude of the second driving voltage Vd2 outputted from the second DC-DC converting part 372.

FIG. 3 is a schematic circuit diagram of an exemplary embodiment of a DC-DC converting part of the light source driving part shown in FIG. 2.

Referring to FIGS. 2 and 3, the first and second DC-DC converting parts 362 and 372 include a switching mode power supply SMPS, an inductor L1, a switching element SW, a diode D1 and a capacitor C1.

The inductor L1 includes a first terminal electrically connected to the switching mode power supply SMPS and a second terminal electrically connected to an output terminal of the switching element SW and an anode of the diode D1. The switching element SW includes an input terminal electrically connected to a ground terminal, a control terminal which receives a control signal CS, e.g., the first control signal CS1 or the second control signal CS2 applied from the first multi-channel current control part 362 or the second multi-channel current control part 374, respectively, and an output terminal electrically connected to the second terminal of the inductor L1 and the anode of the diode D1. A first terminal of the capacitor C1 is electrically connected to a cathode of the diode D1, and a second terminal of the capacitor C1 is electrically connected to the ground terminal.

The first DC-DC converting part 362 and the second DC-DC converting part 372 adjust amplitudes of the first driving voltage Vd1 and the second driving voltage Vd2, respectively, applied to the first driving block BD1 and the second driving block BD2, respectively, in response to the control signal CS, e.g., the first control signal CS1 (FIG. 2) or the second control signal CS2 (FIG. 2), respectively, inputted to the control terminal of the switching element SW.

Referring again to FIG. 2, the switching part 380 includes a first switching element TR1, a second switching element TR2, a third switching element TR3 and a fourth switching element TR4. The switching control part 380 selectively outputs the first driving voltage Vd1 and the second driving voltage Vd2 outputted from the first DC-DC converting part 362 and the second DC-DC converting part 372, respectively, to the first driving block BD1 and the second driving block BD2, respectively, in response to one or more of a first selection signal SE1, a second selection signal SE2, a third selection signal SE3 and a fourth selection signal SE4 applied from the switching control part 390.

As shown in FIG. 2, the first switching element TR1 includes an input terminal electrically connected to an output terminal of the first DC-DC converting part 362, an output terminal electrically connected to an input terminal of the first driving block BD1 and a control terminal which receives the first selection signal SE1 from the switching control part 390.

The second switching element TR2 includes an input terminal electrically connected to an output terminal of the first DC-DC converting part 362, an output terminal electrically connected to an input terminal of the second driving block BD2 and a control terminal which receives the second selection signal SE2 from the switching control part 390.

The third switching element TR3 includes an input terminal electrically connected to an output terminal of the second DC-DC converting part 372, an output terminal electrically connected to an input terminal of the first driving block BD1 and a control terminal which receives the third selection signal SE3 from the switching control part 390.

The fourth switching element TR4 includes an input terminal electrically connected to the output terminal of the second DC-DC converting part 372, an output terminal electrically connected to an input terminal of the second driving block BD2 and a control terminal which receives the fourth selection signal SE4 from the switching control part 390.

The switching control part 390 outputs the first to fourth selection signals SE1 to SE4, respectively, to the first to fourth switching elements TR1 to TR4, respectively, in response to a mode determining signal received from the dimming signal processing part 310 (FIG. 1). In an exemplary embodiment, the first to fourth selection signals SE1 to SE4, respectively, are varied in accordance with a driving mode of the light source module 200. For example, when the driving mode is a normal driving mode, which drives the light source module 200 by each of the light-emitting blocks B, the switching control part 390 outputs selection signals, e.g., the first selection signal SE1 and the fourth selection signal SE4, so that the first and fourth switching elements TR1 and TR4, respectively, are turned on, while the second and third switching elements TR2 and TR3, respectively, are turned off. Thus, the first driving block BD1 receives the first driving voltage Vd1 applied from the first drive chip 360, and the second driving block BD2 receives the second driving voltage Vd2 applied from the second drive chip 370.

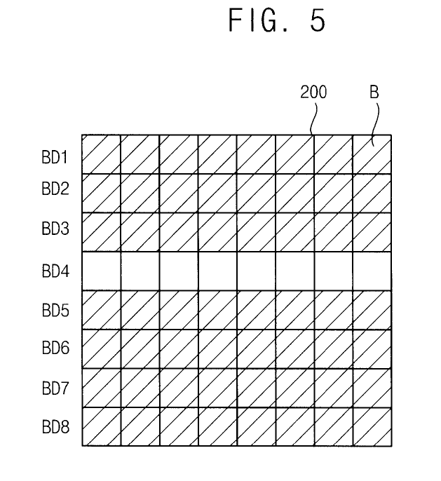

When a driving mode of the light source module 200 is not the normal driving mode, e.g., is an increased luminance mode which drives a predetermined light-emitting block at a higher luminance than a luminance corresponding to a gradation data of the image signal DS, the switching control part 390 outputs selection signals such that a driving voltage of non-predetermined driving blocks (e.g., driving blocks except for the predetermined driving block including a predetermined light-emitting block) are provided to the predetermined light-emitting block in the predetermined driving block, as will be described in further detail below with reference to FIGS. 4 and 5. In an exemplary embodiment, for example, the increased luminance mode, e.g., a mode which drives the predetermined light-emitting block to display a higher luminance than a luminance corresponding to a gradation data of the image signal DS, may include, for example, a boosting mode and a scanning mode. More specifically, the boosting mode is a mode in which the predetermined light-emitting block is driven with a luminance which is a few times greater than a luminance of a white driving. On the other hand, the scanning mode is a mode in which the predetermined blocks are driven by a line unit. In the scanning mode, a driving timing of the normal driving mode is divided to drive by the line unit, and a luminance of the predetermined blocks is thereby decreased. Thus, during the scanning mode, an output of the light-emitting blocks is increased. For example, when the first driving block BD1 is driven in at a higher luminance than a luminance of a full white driving, and the second driving block BD2 is driven in a black luminance, the first and third switching elements TR1 and TR3, respectively, are turned on, while the second and fourth switching elements TR2 and TR4, respectively, are turned off. Thus, the first driving voltage Vd1 applied from the first DC-DC converting part 362 and the second driving voltage Vd2 applied from the second DC-DC converting part 372 are provided to the first driving block BD1. Therefore, the first driving block BD1 is driven at a luminance greater than a luminance of the full white driving.

The light source driving part 350 according to an exemplary embodiment may further include a plurality of output control switching elements S1 to S8 connected to output terminals of each of the light-emitting blocks B, as shown in FIG. 2. The output control switching elements S1 to S8 are turned on during an interval in which the light-emitting blocks B are illuminated, and are turned off during an interval in which the light-emitting blocks B are not illuminated.

The switching control part 390 controls the switching elements S1 to S8, such that outputs at the output terminals of the first DC-DC converting part 362 and the second DC-DC converting part 372 are changed based on a status of whether the switching elements S1 to S8 are turned off.

FIG. 4 is a plan view of an exemplary embodiment of a light source module for explaining an exemplary embodiment of a method of driving a light source in a boosting mode according to the present invention.

As illustrated in FIG. 4, the light source module 200 includes 8×8 light-emitting blocks B. The light-emitting blocks B are divided into a first driving block BD1, a second driving block BD2, a third driving block BD3, a fourth driving block BD4, a fifth driving block BD5, a sixth driving block BD6, a seventh driving block BD7 and an eighth driving block BD8.

When the light source module 200 is divided into a first light-emitting area 200a having a black luminance level and a second light-emitting area 200b having a white luminance level, and the first light-emitting area 200a is greater than a predetermined reference value, the second light-emitting area 200b is driven in the boosting mode. Thus, the second light-emitting area 200b is driven with a higher luminance level than a full white luminance level in the normal driving mode. For example, when a full white luminance of the second light-emitting area 200b in the normal driving mode is about 500 nits, a luminance of the second light-emitting area 200b in the boosting mode is increased to about 1000 nits. In order to drive the second light-emitting area 200b in the boosting mode, increased power is required. However, to drive the first light-emitting area 200a, a relatively low power consumption is required or, alternatively, power is not required to drive the first light-emitting area 200a. Thus, a driving voltage provided to the first light-emitting area 200a by controlling the first switching part 382 and the second switching part 384 is provided to the second light-emitting area 200b. As a result, a driving voltage corresponding to a driving block DB corresponding to the first light-emitting area 200a, which is adjacent to the second light-emitting area 200b, is applied to the second light-emitting area 200b. For example, as shown in FIG. 4, to boost a portion of the light-emitting blocks B included in the third and fourth driving blocks BD3 and BD4, respectively, the third driving block BD3 receives a driving voltage of the second driving block BD2, and the fourth driving block BD4 receives a driving voltage of the fifth driving block BD5.

FIG. 5 is a plan view of an exemplary embodiment of a light source module for explaining an exemplary embodiment of a method of driving a light source in a scanning mode according to the present invention.

Referring to FIG. 5, the light source module 200 according to an exemplary embodiment includes 8×8 light-emitting blocks B. The light-emitting blocks B include a first driving block BD1, a second driving block BD2, a third driving block BD3, a fourth driving block BD4, a fifth driving block BD5, a sixth driving block BD6, a seventh driving block BD7 and an eighth driving block BD8. In the scanning mode, the light source module 200 is sequentially driven by the driving block unit, e.g., in line units.

As described in greater detail above, when the light source module 200 is driven by line units, a luminance is decreased. As a result an output of the light-emitting blocks in an exemplary embodiment is increased. Specifically, a driving voltage of a previous driving block and/or a subsequent driving block, is provided to a current driving block which will be currently driven, and a luminance of the current driving block may is thereby. For example, as shown in FIG. 5, when the current driving block is the fourth driving block BD4, for example, a driving voltage from at least one of the first to third driving blocks BD1 to BD3, respectively, may be provided to the fourth driving block BD4. Alternatively, a driving voltage from at least one of the fifth to seventh driving blocks BD5 to BD7, respectively, may be provided to the fourth driving block BD4. More specifically, a driving voltage of the third driving block BD3 and/or the fifth driving block BD5 adjacent to the fourth driving block BD4 may be provided to the fourth driving block BD4.

Although exemplary embodiments described herein have been described as condensing a voltage of a driving block which is not driven when the LCD device is driven in the scanning mode, alternative exemplary embodiments of the present invention are not limited thereto. For example, when driving the LCD device in the scanning mode, when a predetermined driving block which should be driven at a high luminance level greater than a white level, the driving voltage of any remaining driving block may be provided to the driving block to be driven at the high luminance.

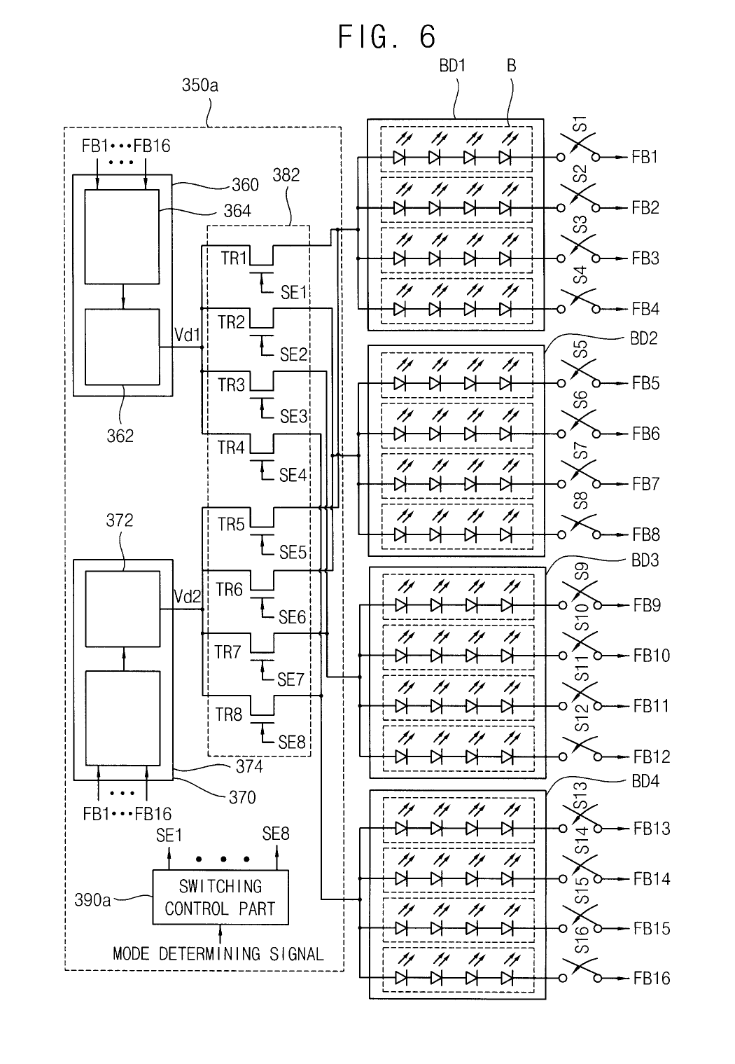

FIG. 6 is a schematic circuit diagram of an alternative exemplary embodiment of a light source driving part of the display apparatus shown in FIG. 1.

A light source driving part 350a according to an exemplary embodiment is substantially the same as the light source driving part 350 of FIG. 2 except for driving blocks connected to the first and second drive chips 360 and 370. Thus, the same reference numerals will be used to refer to the same or like parts as those described in FIG. 2, and any repetitive detailed description thereof may hereinafter be omitted.

Referring to FIGS. 1 and 6, the light source driving part 350a according to an alternative exemplary embodiment includes a first drive chip 360, a second drive chip 370, a switching part 382 and a switching control part 390a.

The switching part 382 includes a first switching element TR1, a second switching element TR2, a third switching element TR3, a fourth switching element TR4, a fifth switching element TR5, a sixth switching element TR6, a seventh switching element TR7 and an eighth switching element TR8.

The first drive chip 360 includes a first DC-DC converting part 362 and a first multi-channel current control part 364. The first DC-DC converting part 362 provides a first driving voltage Vd1 to a plurality of driving blocks connected through the first to fourth switching elements TR1 to TR4, respectively. As shown in FIG. 6, for example, the first DC-DC converting part 362 is connected to a first driving block BD1, a second driving block BD2, a third driving block BD3 and a fourth driving block BD4 through the first to fourth switching elements TR1 to TR4, respectively. The first to fourth driving blocks BD1 to BD4, respectively, may be adjacent to each other, as shown in FIG. 6.

The second drive chip 370 includes a second DC-DC converting part 372 and a second multi-channel current control part 374. The second DC-DC converting part 372 provides a second driving voltage Vd2 to a plurality of driving blocks connected through the fifth to eighth switching elements TR5 to TR8, respectively. As shown in FIG. 6, for example, the second DC-DC converting part 372 may be connected to the first to fourth driving blocks BD1 to BD4, respectively, through the fifth to eighth switching elements TR5 to TR8, respectively.

The first switching element TR1 is connected between an output terminal of the first DC-DC converting part 362 and an input terminal of the first driving block BD1 to transmit the first driving voltage Vd1 outputted from the first DC-DC converting part 362 to the first driving block BD1.

The second switching element TR2 is connected between the output terminal of the first DC-DC converting part 362 and an input terminal of the second driving block BD2 to transmit the first driving voltage Vd1 to the second driving block BD2.

The third switching element TR3 is connected between the output terminal of the first DC-DC converting part 362 and the input terminal of the third driving block BD3 to transmit the first driving voltage Vd1 to the third driving block BD3.

The fourth switching element TR4 is connected between the output terminal of the first DC-DC converting part 362 and the input terminal of the fourth driving block BD4 to transmit the first driving voltage Vd1 to the fourth driving block BD4.

The fifth switching element TR5 is connected between the output terminal of the second DC-DC converting part 372 and the input terminal of the first driving block BD1 to transmit the second driving voltage Vd2 outputted from the second DC-DC converting part 372 to the first driving block BD1.

The sixth switching element TR6 is connected between the output terminal of the second DC-DC converting part 372 and the input terminal of the second driving block BD2 to transmit the second driving voltage Vd2 to the second driving block BD2.

The seventh switching element TR7 is connected between the output terminal of the second DC-DC converting part 372 and the input terminal of the third driving block BD3 to transmit the second driving voltage Vd2 to the third driving block BD3.

The eighth switching element TR8 is connected between the output terminal of the second DC-DC converting part 372 and the input terminal of the fourth driving block BD4 to transmit the second driving voltage Vd2 to the fourth driving block BD4.

The switching control part 390a outputs first to eighth selection signals SE1 to SE8, respectively, to the first to eighth switching elements TR1 to TR8, respectively, in response to a mode determining signal received from the dimming signal processing part 310 (FIG. 1). For example, when a driving mode of the light source module 200 is a normal driving mode, the switching control part 390 outputs a plurality of selection signals, so that the first, second, seventh and eighth switching elements TR1, TR2, TR7 and TR7, respectively, are turned on, and the third to sixth switching elements TR3, TR4, TR5 and TR6, respectively, are turned off.

When a driving mode of the light source module 200 is an increased luminance mode, e.g., a mode in which a predetermined light-emitting block is driven at a higher luminance than a luminance corresponding to a gradation data of the image signal DS, the switching control part 390 controls the first to eighth switching elements TR1 to TR8, respectively, so that a driving voltage which drives the remaining driving block (e.g., except for the predetermined driving block) is applied to the predetermined driving block, including a predetermined light-emitting block therein. For example, when the predetermined light-emitting block is the second driving block BD2, the switching control part 390a turns on the second and sixth switching elements TR2 and TR6, respectively, and the first driving voltage Vd1 outputted from the first DC-DC converting part 362 and the second driving voltage Vd2 outputted from the second DC-DC converting part 372 are both applied to the second driving block BD2.

Thus, according to exemplary embodiments of the present embodiment, a plurality of driving blocks is connected to one DC-DC converting part, and a number of required DC-DC converting parts is thereby substantially decreased.

Further, according to exemplary embodiments of the present invention as described herein, when a first driving block is driven at a higher luminance than a luminance corresponding to a gradation data of an image signal, both a first driving voltage, which drives the first driving block during normal operation, as well as a second driving voltage, which drives the second driving block during normal operation, are applied to the first driving block. Therefore, an additional DC-DC converting part is not required to obtain an increased luminance output of the first driving block. Moreover, a plurality of driving blocks may be connected to one DC-DC converting part, and a number of required DC-DC converting parts is therefore substantially decreased. Accordingly, manufacturing costs of the DC-DC converting part and the LCD device according to an exemplary embodiment are substantially reduced.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. A method of driving a light source in a normal mode and an increased luminance mode, based on a gradation data of an image signal, by using driving blocks each having a plurality of light-emitting blocks, the method comprising:
applying, during the increased luminance mode, both a first driving voltage which drives a first driving block of the driving blocks during the normal mode, and a second driving voltage which drives a second driving block of the driving blocks during the normal mode, to the first driving block to increase a luminance of the first driving block when the first driving block is driven by a luminance value greater than a luminance corresponding to the gradation data of the image signal.

2. The method of claim 1, wherein the second driving block is adjacent to first driving block.

3. The method of claim 1, wherein the increased luminance mode comprises at least one of a boosting mode and a scanning mode.

4. The method of claim 1, wherein the luminance level of the first driving block is substantially greater than a luminance level of the second driving block.

5. A light source apparatus comprising:
a first driving block and a second driving block each comprising a plurality of light-emitting blocks;
a first drive chip and a second drive chip comprising a first output terminal and a second output terminal, respectively;
a switching part comprising a plurality of switching elements connected to the first output terminal and the second output terminal, switching elements of the plurality of switching elements being connected in electrical parallel with each other, the switching part being configured to selectively output at least one of a first driving voltage from the first drive chip and a second driving voltage from the second drive chip to at least one of the first driving block and the second driving block; and
a switching control part which turns on first switching elements of the plurality of switching elements connected to the first driving block and which turns off second switching elements of the plurality of switching elements connected to the second driving block to increase a luminance of the first driving block when the first driving block is driven by a luminance value greater than a luminance corresponding to a gradation data of an image signal.

6. The light source apparatus of claim 5, wherein the luminance of the first driving block is substantially greater than a luminance of the second driving block.

7. The light source apparatus of claim 5, wherein the first drive chip and the second drive chip comprise:
a multi-channel current control part comprising input terminals connected to output terminals of each light-emitting block of the plurality of light-emitting blocks included in the first driving block and the second driving block, the multi-channel current control part configured to control an amplitude of a driving current applied to each of the light-emitting blocks based on a plurality of feedback signals that are applied to the input terminals from each of the light-emitting blocks; and
a DC-DC converting part which converts an amplitude of one of the first driving voltage and the second driving voltage applied to one of the first driving block and the second driving block based on a control signal from the multi-channel current control part.

8. The light source apparatus of claim 7, wherein the DC-DC converting part comprises:
an inductor including a first terminal electrically connected to a voltage source;
a switching element having an output terminal electrically connected to a second terminal of the inductor and an input terminal electrically connected to a ground terminal;
a diode having an anode electrically connected to the second terminal of the inductor and the output terminal of the switching element; and
a capacitor electrically connected between a cathode of the diode and the ground terminal.

9. The light source apparatus of claim 5, further comprising output control switching elements connected to output terminals of each light-emitting block of the plurality of light-emitting blocks included in the first driving block and the second driving block,
wherein the switching control part one of turns on the output control switching elements and turns off the output control switching elements based on a driving mode of each of the light-emitting blocks.

10. The light source apparatus of claim 9, wherein the switching control part controls the first switching elements and the second switching elements such that at least one of the first driving voltage and the second driving voltage is varied when the output control switching elements are turned off

11. The light source apparatus of claim 5, wherein each light-emitting block of the plurality of light-emitting blocks comprises white light-emitting diodes connected in electrical series with each other.

12. The light source apparatus of claim 5, wherein each light-emitting block of the plurality of light-emitting blocks comprises:
red light-emitting diodes connected in electrical series with each other;
green light-emitting diodes connected in electrical series with each other; and
blue light-emitting diodes connected in electrical series with each other.

13. A display apparatus comprising:
a display panel which displays an image;
a light source module which provides the display panel with light, the light source module comprising a first driving block and a second driving block each comprising a plurality of light-emitting blocks;
a first drive chip and a second drive chip comprising a first output terminal and a second output terminal, respectively, the first drive chip configured to output a first driving voltage to the first output terminal and the second drive chip configured to output a second driving voltage to the second output terminal;
a switching part comprising a plurality of switching elements connected to the first output terminal and the second output terminal, switching elements of the plurality of switching elements being connected in electrical parallel with each other, the switching part being configured to selectively output at least one of the first driving voltage and the second driving voltage to at least one of the first driving block and the second driving block; and
a switching control part which turns on first switching elements of the plurality of switching elements connected to the first driving block and which turns off second switching elements of the plurality of switching elements connected to the second driving block to increase a luminance of the first driving block when the first block is driven by a luminance value greater than a luminance corresponding to a gradation data of an image signal.

14. The display apparatus of claim 13, wherein the luminance of the first driving block is substantially greater than a luminance of the second driving block.

15. The display apparatus of claim 13, wherein the first drive chip and the second drive chip comprise:
a multi-channel current control part comprising input terminals connected to output terminals of each light-emitting block of the plurality of light-emitting blocks included in the first driving block and the second driving block, the multi-channel current control part configured to control an amplitude of a driving current applied to each of the light-emitting blocks based on a plurality of feedback signals that are applied to the input terminals from each of the light-emitting blocks; and
a DC-DC converting part which converts an amplitude of one of the first driving voltage and the second driving voltage applied to one of the first driving block and the second driving block based on a control signal from the multi-channel current control part.

16. The display apparatus of claim 15, wherein the DC-DC converting part comprises:
an inductor including a first terminal electrically connected to a voltage source;
a switching element having an output terminal electrically connected to a second terminal of the inductor and an input terminal electrically a ground terminal;
a diode having an anode electrically connected to the second terminal of the inductor and the output terminal of the switching element; and
a capacitor electrically connected between a cathode of the diode and the ground terminal.

17. The display apparatus of claim 13, further comprising output control switching elements connected to output terminals of each light-emitting block of the plurality of light-emitting blocks,
wherein the switching control part one of turns on the output control switching elements and turns off the output control switching elements based on a driving mode of each of the light-emitting blocks.

18. The display apparatus of claim 17, wherein the switching control part controls the first switching elements and the second switching elements such that at least one of the first driving voltage and the second driving voltage is varied when the output control switching elements are turned off

19. The display apparatus of claim 13, wherein each light-emitting block of the plurality of light-emitting blocks comprises light-emitting diodes connected in electrical series with each other.

20. The display apparatus of claim 13, wherein each light-emitting block of the plurality of light-emitting blocks comprises:
red light-emitting diodes connected in electrical series with each other;
green light-emitting diodes connected in electrical series with each other; and
blue light-emitting diodes serially connected in electrical series with each other.
